(19) United States
(12) Patent Application Publication
(10) Pub. No.: US 2006/0152574 A1
(43) Pub. Date: Jul. 13, 2006

(54) Laser writing head for a printer

(75) Inventor: Alberto Campanini, Fidenze (Parma) (IT)

Correspondence Address: LACKENBACH SIEGEL, LLP, LACKENBACH SIEGEL BUILDING, 1 CHASE ROAD, SCARSDALE, NY, 10583, US

(73) Assignee: Custom Engineering Spa, Fontevivo (Parma) (IT)

(21) Appl. No.: 11/272,277

(22) Filed: Nov. 10, 2005

(30) Foreign Application Priority Data
Jan. 13, 2005 (EP) 05425010.5

(51) Int. Cl. B41J 2/435

(52) U.S. Cl. 347/224

(57) ABSTRACT

A laser writing head for a printer provided with a solid laser for transmitting a radiation beam incident onto mirrors carried by a hexagonal polygon and mounted onto a movable plate for driving the mirrors. A sensor also senses the movement of the movable plate and is transmitted to a control for controlling the power of the laser beam on the basis of collected data to control the number of rotations. The transmitted radiation beam is then reflected by the mirrors to form a pair of return radiation beams, one of which is reflected towards a photosensor to provide a retroaction line and a second of which is directed onto a collimating lens which concentrates the reflected beam to form a further or collimated beam which is transmitted through a mask having an opening for permitting the laser beam to be impressed onto light-sensitive paper to form a writing.

### BACKGROUND OF THE INVENTION

This invention relates to printers, and more particularly to a laser writing head for a printer.

### DESCRIPTION OF PRIOR ART

In the field of the printers for cash registers or for printers which use thermic cash vouchers in which writing or printing onto paper are usually or conventionally based on a transmission of heat generated and applied to a writing point for working or providing a visible indication on paper using resistance or applying the visible indication to a resistive layer. The writing point or protruding part of a thermic head generally generates heat when fed by current between a resistive layer and a rubber pressure roll. As is well known and understood, resistance is responsible for heat generation and thereby is effective to determine various printing positions on the paper. Graphic signs are formed onto the paper so that in biunique correspondence a readable indicia results from impulses, resistances and alphanumeric codes to provide for various forms of writing onto the thermic paper or a thermic paper cash voucher.

The disposition of the components of this type of apparatus always includes a thermic head, together with a heating layer, a rubber roll placed under the thermic head and the paper with a system of elastic connections comprising springs and parts to maintain the thermic head in position and to place or position the thermic head onto the paper, and various components for connection to a frame and a paper support. This structural arrangement, with the thermic head and connected parts, is used for all of the uses of the thermic printers, i.e. onto thermic paper, and this results in several problems such as a need or requirement, for a correct working or operation, a definite disposition of the thermic head in relation to the paper and therefore requires the use of a particular kind of paper and to result in or be subjected to a wear and tear of the various parts in contact with each other.

### SUMMARY OF THE INVENTION

In order to overcome the aforesaid difficulties and problems existing in the prior art, this invention proposes the provision of a printing apparatus which provides for the elimination of the conventional thermic head and the connected and related parts or components pertaining to the thermic head.

Therefore, a purpose of the invention is to overcome the problems resulting from the use of the previously cited parts or components and to avoid the use of the prior art parts forming part of a thermic printer, while operating at the same time and producing a drastic reduction of the required mechanical parts and the fraction between operating parts which causes losses in the printing quality due to the wear of the various components.

A feature of the invention is the use of a laser writing head for the printer.

To these ends, the present invention consists in the provision of a laser writing head for a printer which includes a solid laser for transmission of a radiation beam onto and incident onto mirrors placed onto an outer surface of an hexagonal polygon which is mounted onto a movable substantially circular plate for room or location considerations and placed into motion by means, for example, of an electric motor or other suitable movement means, a sensor is provided to cause and control the rotation of the electric motor or other movement means, a first radiation beam is reflected from one of the mirrors to form a first return radiation beam towards a photosensor to realize or to produce a retroaction line for the laser; and the mirrors while rotating reflect the radiation beam transmitted by the laser to form a second or a further radiation beam which is reflected from the mirrors onto a light-sensitive paper after passing through a collimating lens which forms a concentrated beam over or by the collimating lens forming a collimated beam which passes through an opening provided and with a mask that provides for the laser beam to be impressed onto light-sensitive paper placed over a backing member or carried by a paper roll.

Another feature of the invention is that the sensor controls the number of rotations carried out and imparted to the movable plate carrying the mirrors and, on the basis of collected data, so as to permit an increase or a decrease in the number of rotation turns of the same plate by means of use of electronic adjustment and control devices. The photosensor regulates the power apparatus applied to the laser.

A further feature is that the apparatus and various parts are positioned in a frame body or enclosure of dimensions similar to that of the bodies or enclosures in use for the printers using a thermic head so that upgrades and modifications are easily accomplished. The dimensional configuration of the frame body is similar to that of a frame for use with a thermic head.

Yet another feature is that the laser beam emitted by the solid laser is a low power beam, and the frequency of the electromagnetic radiations used is that of the ultraviolet rays. The third or reflected laser beam produces a low power beam in response to a transmitted beam for the solid laser.

A further feature of the invention is that the light-sensitive paper changes color with the passing onto it of the laser beam while providing for an energy saving.

More specifically, the present invention provides for a laser writing head for a printer for printing onto light-sensitive paper comprising a solid laser for transmission of a radiation beam, a rotatable hexagonal polygon mounted onto a plate and including a mirror for each side of the hexagonal polygon positioned to receive the transmitted radiation beam onto one of the mirrors, the hexagonal polygon being rotatable by any suitable mechanism relative to the transmitted radiation beam, the mirrors reflecting the transmitted radiation beam to form first and second reflected radiation beams, the first reflected radiation beam being reflected to form a return radiation beam directed towards a photosensor to provide a retroaction line for the laser, the mirrors during rotation also reflect the second reflected radiation beam towards a mask, and the mask is provided with an opening and is positioned between the mirrors and the light-sensitive paper for transmitting the second reflected radiation beam through the opening towards and onto the light-sensitive paper from a collimating lens positioned between said mirrors and said mask for collimating said second reflected beam for concentration over said collimating lens to form a collimated beam which passes through said opening in said mask for directing said second reflected laser beam towards said light-sensitive paper for printing onto the light-sensitive paper.

A paper roll is provided for carrying the light-sensitive paper and having a leading edge for passing between the mask housed in a guide portion and a paper backing member.

With all of the foregoing advantages, it should be noted that an assembly is provided for the laser writing head forming an apparatus for printing without wear or mechanical problems.

Other objects, advantages and the nature of the invention will be readily appreciated from a detailed description of the following accompanying drawings and detailed explanation of the various elements and features shown in the accompanying drawings.

### BRIEF DESCRIPTION OF THE DRAWINGS

FIG. 1 is a schematic perspective view of the apparatus in an open condition showing the novel laser head located within a support body and without an upper cover; and,

FIG. 2 is a side vertical sectional view of a cash register together with the novel laser head and apparatus positioned at the position where previously a thermic head according to the prior art was located.

### LIST OF THE PARTS AND THEIR REFERENCE NUMERALS

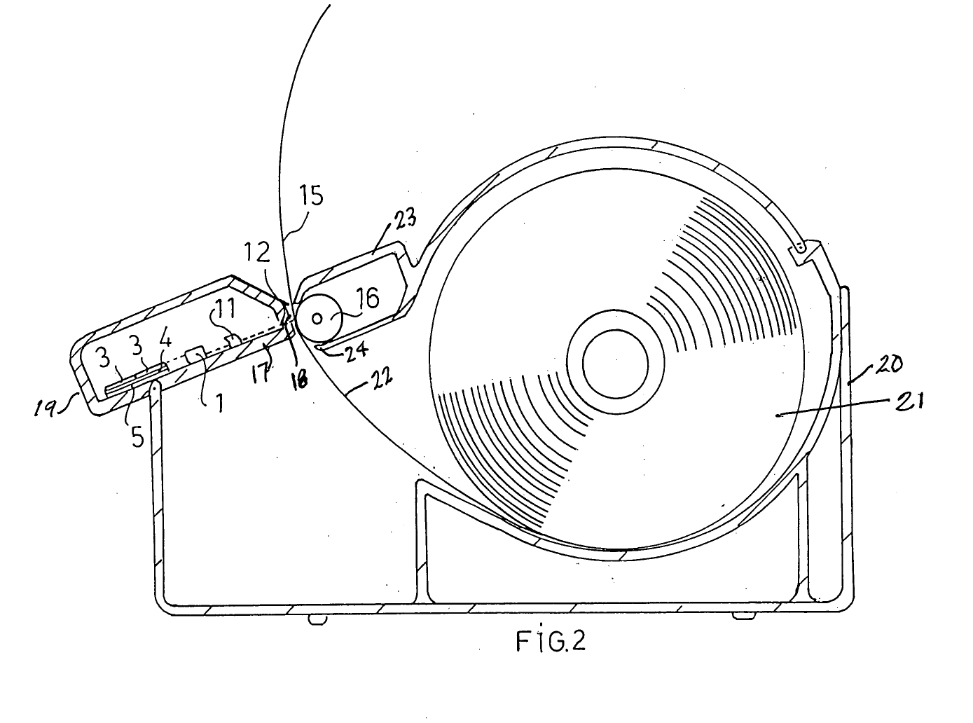

1—solid laser beam transmitter
2—direct radiation or transmission beam
3.—hexagonally-shaped polygon member with six mirrors, one for each side
4.—substantially circular plate
5.—brushless motor
6.—sensor for control of rotation of motor 5
7.—first reflected radiation beam
8.—radiation beam photosensor for receiving first reflected beam
9. apparatus for controlling power of laser beam
10.—second or further reflected radiation beam
11.—collimating lens
12.—third radiation beam or collimated beam
13.—opening
14.—mask provided with opening 13
15.—printed leading edge of light-sensitive paper extending from printing area (FIG. 2)
16.—roll member forming a paper backing member
17.—guide portion
18.—opening in laser enclosure 19
19.—laser enclosure
20.—paper roll enclosure and support therefor
21.—roll of light sensitive paper
22.—unprinted leading edge of light sensitive paper before passing between paper backing member 16 and laser enclosure 19
23.—printing area enclosure for supporting paper backing
24. opening in enclosure 23 through which member 16 partially extends

### DETAILED DESCRIPTION OF THE INVENTION

Referring now more particularly to the drawings which comprises a solid laser 1 positioned within a conventional laser enclosure 19 for generation of and transmission of a laser beam 2.

Mirrors 3 are associated with a substantially circular plate 4 and is provided to support and rotate by means of a movement means such as an electric motor 5 hexagonally-shaped solid polygonal member carrying mirrors 3 having on each sides of the hexagonally-structure mirror 3; six side mirrors are provided, one for each side, each defining an acute angle between two adjacent mirrors. Laser beam 2, as shown, when emitted from solid laser transmitter 1 is directed towards one of the mirrors 3 positioned on one side of the hexagonal polygon and impinges onto one of the six mirrors 3 as the mirrors 3 supported by substantially circular plate 4 are rotated. Plate 4 which carries the mirrors 3 is rotated by brushless motor 5 although other suitable means to rotate mirrors 3 may be used.

Sensor 6 is provided to control the rotation of motor 5, and such control is based on collected data collected by sensor 6 for effectively controlling by means of adjustment and electronic control devices. Sensor 6 is effective to control the increase or decrease of the speed of brushless motor 5 and therefore in turn the speed of rotation of mirrors 3.

After direct radiation or transmission beam 2 impinges onto one of the mirrors 3, two reflected beams are produced. Mirror 3 produces a first reflected radiation beam 7 which is directed towards radiation beam photosensor 8; the first reflected radiation beam 7 is a return radiation beam from mirrors 3 directed towards photosensor 8 for the realization of a retroaction line for solid laser 1.

The power of solid laser 1 is controlled by control apparatus 9.

Control apparatus 9 is associated with solid laser 1, and radiation beam photosensor 8 for regulation of the power of solid laser 1. Photosensor 8 as noted is responsive to first reflected radiation beam 7.

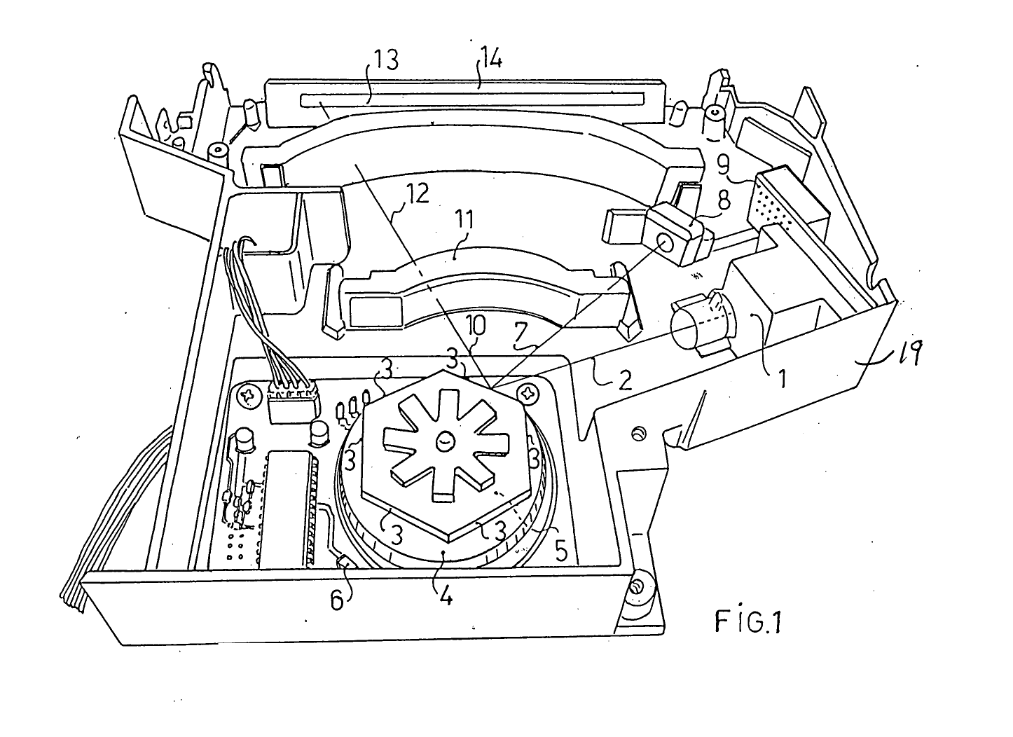

A second or further reflected radiation beam 10 is also reflected from the mirrors 3 as is the first reflected radiation beam 7 in response to the rotation of the mirrors. Second or further reflected radiation beam 10 passes through collimating lens 11 to produce a third or collimated beam 13. Collimating lens 11 is for concentration of the second reflected radiation beam 10 to form the third reflected radiation beam or collimated beam 12 which passes through an elongated narrow opening 13 provided in mask 14. Opening 13 has a wide horizontal extent as shown in FIG. 1 of the drawing so that collimated beam 12 will pass through opening 13 depending on the rotation of plate 4 and the position of mirrors 3.

Referring now more particularly to FIG. 2 of the drawings which illustrates light-sensitive paper 15 passing in front of a roll member or paper backing member 16 and between guide portion 17 and roll member 16. Guide portion 17 has opening 18 forming part of laser enclosure 19 containing solid laser 1, and its associated parts described in connection with FIG. 1.

Also shown in FIG. 2 is conventional enclosure 20 containing a conventional roll of light-sensitive paper 21 having an unprinted leading edge 22 extending from the roll of paper 21 to backing member 16 and guide portion 17 through which paper 21 passes for printing thereon.

Paper backing member 16 is contained within printing area enclosure 23 and is provided with an opening 24 through which a portion of roll member or paper backing member protrudes and is substantially aligned with opening 18 through which collimated beam 12 passes for imprinting onto light-sensitive paper 15.

Roll member 16 and guide portion 17 together with the leading edge 22 of light-sensitive paper 15 define a printing area between printing area enclosure 23 and guide portion 17.

The unprinted leading edge 22 of light-sensitive paper 21 in cooperation with printing area enclosure 23 and roll member 16 and opening 24 for exposure of unprinted leading edge 21 of paper 22 passes over roll member or backing member 16, and beyond enclosure 23 and laser enclosure 19 which provides for an exit portion for leading edge 22 of light-sensitive paper 15 for printing thereon and exiting with a printed leading edge 15 which is formed for removal of printed material.

Enclosure 19 is provided with opening 18 through which the collimated or third reflected radiation laser beam 12 impinges onto paper 22 after it passes through opening 13 in mask 14.

Light sensitive paper 22 passes over roll member or backing member 16 and is guided by the pathway formed between opening 24 of printing area enclosure opening 18 in guide portion 17 of apparatus 19.

Opening 18 in laser enclosure 19 permits third reflected radiation laser beam or collimated beam 12 to impress onto light-sensitive paper 21 as the unprinted leading edge 22 of light-sensitive paper 21 moves over the roll member or backing member 16. The third reflected laser beam or collimated beam 12 is quite capable of writing onto the light-sensitive paper 21. The biunique correspondence between the signs traced to the beam generated by solid laser 1 and the signs in alphanumeric characters is given to cards and application components normally used to drive the writing in the laser devices.

The apparatus according to the teachings of the invention avoids the use of a thermic head for writing onto thermic paper using the above cited parts contained in a frame body of dimension similar to that of the bodies in use for thermic heads.

Moreover, the third reflected radiation laser beam or collimated beam 12 produced from the transmitted laser beam transmitted from the solid laser 1 is a low power beam.

In a preferred embodiment of the invention, the frequency of the electromagnetic radiations used is that of ultraviolet rays and the chemical paper used for the printing is of the corresponding kind, i.e. sensitive to the ultraviolet radiations. The light-sensitive paper 21 changes color as it passes over roll 16 and between the roll 16 and the third or collimated beam. This permits a saving of current used for the apparatus according to the invention, which is sufficient and not a very high power to change color.

The invention provides for faster printers, without moving parts, which wear due to friction on the papers and, as already indicated, has low energetic use. The apparatus according to the teachings also permits a moderate energy use such that there is no more heading required for the writing actuated on thermic paper. The apparatus has, moreover, a larger velocity and a better quality of printing in little time, due to the less thermic inertia. The apparatus is optimal for the very quick printings and, for its low energetic use, for the portable devices or for large quantities.

It will be obvious to those skilled in the art that various changes and modifications may be made without departing from the scope of the invention.

1. A laser writing head for a printer comprising:
a solid laser for transmission of a first or transmitted radiation beam;
mirrors positioned on an hexagonal polygon mounted onto a plate, said first radiation beam being transmitted from said solid laser onto said mirrors;
means for rotation of said hexagonal polygon;
said mirrors reflecting said first radiation beam to form a second beam or reflected radiation beam to form a return radiation beam directed towards a photosensor to provide a retroaction line for said laser;
said mirrors during rotation also reflect said first or transmitted radiation beam to form a third beam or a further reflected radiation beam transmitted towards and impressed onto a collimating lens for collimating said second reflected beam for concentrating over said collimating lens to form a fourth beam or a third reflected or collimated beam inside an opening provided with a mask that permits said second reflected laser beam for impression onto light-sensitive paper carried by a paper roll in the printer.

2. The writing head as claimed in claim 1, wherein said sensor controls the number of carried out rotations of said plate and, on the basis of collected data, said sensor provides for an increase or a decrease in number of rotation turns of said plate with use of electronic adjustment and control devices.

3. The laser writing head as claimed in claim 1, wherein said photosensor regulates power applied to said laser.

4. The laser writing head as claimed in claim 1, wherein said collimated beam is capable of writing onto said light-sensitive paper.

5. The laser writing head as claimed in claim 1, wherein said laser and said printer are housed in a frame body having a dimensional configuration similar to that of a frame for use with a thermic head.

6. The laser writing head as claimed in claim 1, wherein said third or reflected laser beam produces a low power beam in response to a transmitted beam for said solid laser.

7. The laser writing head as claimed in claim 1, wherein the frequency of the used electromagnetic radiations is that of the ultraviolet rays.

8. The laser writing head as claimed in claim 1, wherein the light-sensitive paper changes color with a passing onto it of the laser beam permitting an energy saving.

9. The laser writing head as claimed in claim 1, wherein said hexagonal polygon is responsive to a rotation responsive sensor.

10. The laser writing head as claimed in claim 9, wherein said laser and said printer are placed into a frame body having dimensions similar to that of a frame for use with a thermic head.

11. A laser writing head for a printer for printing onto light-sensitive paper comprising:
a solid laser for transmission of a radiation beam;
a rotatable hexagonal polygon mounted onto a plate and including a mirror for each side of said hexagonal polygon positioned to receive said transmitted radiation beam onto one of said mirrors;
means for rotation of said hexagonal polygon relative to said transmitted radiation beam;
said mirrors reflecting said transmitted radiation beam to form first and second reflected radiation beams, said first reflected radiation beam being reflected to form a return radiation beam directed towards a photosensor to provide a retroaction line for said laser;
said mirrors during rotation also reflect said second reflected radiation beam towards a mask and a collimating lens positioned between said mask and said mirrors; and
said mask being provided with an opening and positioned between said mirrors and said light-sensitive paper for transmitting said second reflected radiation beam towards and onto said light-sensitive paper from said collimating lens positioned between said mirrors and said light-sensitive paper for collimating said second reflected beam for concentration over said collimating lens to form a collimated beam which passes through said opening in said mask directing said second reflected laser beam for printing onto the light-sensitive paper.

12. The laser writing head as claimed in claim 11, including a paper roll for carrying said light-sensitive paper and having a leading edge for passing between said mask housed in a guide portion and a paper backing member.

13. The writing head as claimed in claim 11, wherein said sensor controls the number of carried out rotations of said plate and, on the basis of collected data, said sensor provides for an increase or a decrease in number of rotation turns of said plate with use of electronic adjustment and control devices, and said photosensor regulates power applied to said solid laser.

14. The laser writing head as claimed in claim 11, where said collimated beam is capable of writing onto said light-sensitive paper and produces a low power beam in response to the transmitted beam from said solid laser.

15. The laser writing head as claimed in claim 11, wherein the frequency of the used electromagnetic radiations is that of the ultraviolet rays, and the light-sensitive paper changes color with a passing onto said light-sensitive paper of the laser beam permitting an energy saving.
